(19) United States
(12) Patent Application Publication
(10) Pub. No.: US 2025/0088281 A1
(43) Pub. Date: Mar. 13, 2025

(54) OPTICAL NODE APPARATUS AND SIGNAL SUPERPOSITION METHOD

(71) Applicant: NIPPON TELEGRAPH AND TELEPHONE CORPORATION, Tokyo (JP)

(72) Inventors: Takuya KANAI, Musashino-shi (JP); Kazutaka HARA, Musashino-shi (JP); Shin KANEKO, Musashino-shi (JP)

(73) Assignee: NIPPON TELEGRAPH AND TELEPHONE CORPORATION, Tokyo (JP)

(21) Appl. No.: 18/721,627

(22) PCT Filed: Dec. 20, 2021
(86) PCT No.: PCT/JP2021/046963

§ 371 Date: Jun. 18, 2024

(51) Int. Cl. H04B 10/54

(52) U.S. Cl. CPC H04B 10/54

(57) ABSTRACT

An optical node device includes a modulation amplitude correction unit which generates correction information for correcting an amplitude of a modulated signal based on a control signal so that a superimposition ratio when superimposing the control signal for controlling a subscriber device on an optical signal becomes a desired superimposition ratio; a driver which converts the control signal input from the outside into a modulated signal, and adjusts the amplitude of the modulated signal, using the correction information generated by the modulation amplitude correction unit; and a superimposing unit which superimposes the modulated signal adjusted by the driver on the optical signal.

### TECHNICAL FIELD

The present invention relates to an optical node device and a signal superimposing method.

### BACKGROUND ART

In the related art, there has been proposed a system in which a subscriber device communicates with an opposite subscriber device by using an optical signal via an optical node device called a photonic gateway. FIG. 8 is a diagram for describing a configuration of an optical communication system 100 of the related art. As shown in FIG. 8, the optical communication system 100 of the related art includes a plurality of subscriber devices 200-1 to 200-3, a plurality of subscriber devices 300-1 to 300-3, a plurality of optical node devices 350-1 to 350-2, and a plurality of control units 400-1 to 400-2. The optical node device 350-1 and the optical node device 350-2 are connected via an optical communication NW 600 made up of an optical transmission line.

A section between the subscriber devices 200-1 to 200-3 and the optical node device 350-1, and a section between the subscriber devices 300-1 to 300-3 and the optical node device 350-2 are called optical access sections. A section between the optical node device 350-1 and the optical node device 350-2 is called a relay section. In the example shown in FIG. 8, the subscriber devices 200-1 and 200-2 and the optical node device 350-1 are connected by a single-core optical transmission line, and the subscriber device 200-3 and the optical node device 350-1 are connected by a two-core optical transmission line.

The optical node device 350-1 includes an optical SW 500, a plurality of transmission/reception separation units 510-1 to 510-2, a plurality of wavelength multiplexer/demultiplexers 520-1 to 520-2, and a plurality of signal superimposing units 530-1 to 530-3. The optical node device 350-2 includes an optical SW 550, a plurality of transmission/reception separation units 560-1 to 560-2, a plurality of wavelength multiplexers/demultiplexers 570-1 to 570-2, and a plurality of signal superimposing units 580-1 to 580-3. A control unit 400-1 manages the subscriber device 200 and controls the operation of the optical node device 350-1. A control unit 400-2 manages the subscriber device 300 and controls the operation of the optical node device 350-2.

Here, a state in which the subscriber device 200-1 and the subscriber device 300-1 communicate with each other is considered. Each of the subscriber devices 200 and 300 is provided with a wavelength variable transmitter/receiver. For example, the subscriber device 200-1 transmits an optical signal by using a wavelength allocated by a subscriber device management control unit 420-1 of the control unit 400-1 in advance. For wavelength allocation, a method described in, for example, NPLs 1 and 2 is used. Similarly, the subscriber device 300-1 transmits an optical signal by using a wavelength allocated by a subscriber device management control unit 420-2 of the control unit 400-2 in advance. In this way, in the optical communication system 100, communication is performed between the subscriber device 200 and the subscriber device 300 by using the wavelengths assigned from the control units 400-1 and 400-2.

For example, in the subscriber devices 200-1 and 200-2, single-core bidirectional communication is performed inside the optical SWs 500 and 550 in an optical access section and respective optical node devices 350-1 and 350-2. Therefore, transmission/reception separation units 510-1 and 510-2 are provided between the optical SW 500 and the wavelength multiplexers/demultiplexers 520-1 and 520-2, and the transmission/reception separation units 510-1 and 510-2 separate or multiplex the wavelengths of transmission and reception. Further, the transmission/reception separation units 510-1 and 510-2 and the wavelength multiplexers/demultiplexers 520-1 and 520-2 are connected by an optical transmission line, respectively.

Similarly, transmission/reception separation units 560-1 and 560-2 are provided between the optical SW 550 and wavelength multiplexers/demultiplexers 570-1 and 570-2, and the transmission/reception separation units 560-1 and 560-2 separate or multiplex the wavelengths of transmission and reception. Further, the transmission/reception separation units 560-1 and 560-2 and the wavelength multiplexers/demultiplexers 570-1 and 570-2 are connected by an optical transmission line, respectively. Therefore, the relay sections are connected by a two-core optical transmission line. As means for realizing the transmission/reception separation units 510 and 560, there is, for example, a circulator.

Although the case where the single-core bidirectional communication is performed in the optical access section as in the conventional optical access communication is considered for the subscriber devices 200-1 and 200-2, a case where the optical access section is connected by an individual optical fiber by transmission and reception as in the subscriber devices 200-3 and 300-3 is also assumed. At this time, the connection between the optical SW and the wavelength multiplexer/demultiplexer has a connection configuration that does not involve the transmission/reception separation unit.

As shown in FIG. 8, by providing a signal superimposing unit 530 or 580 for superimposing a new optical signal between the wavelength multiplexer/demultiplexer 520 and the transmission/reception separation unit 510 or between the wavelength multiplexer/demultiplexer 570 and the transmission/reception separation unit 560, the new signal can be superimposed on the optical signal transmitted from each optical node device to the subscriber device. For example, a new signal is superimposed on an optical signal transmitted from the subscriber device 300 to the subscriber device 200 by the signal superimposing unit 530. As a signal to be newly superimposed on the optical signal, there is, for example, an auxiliary management and control channel (AMCC) signal. (see, for example, NPL 3). On the other hand, the subscriber device can selectively receive not only the original optical signal but also a newly superimposed optical signal.

### CITATION LIST

### Non Patent Literature

[NPL 1] Kanai, “Photonic Gateway for All-Photonics Network,” IEICE General Conference, B-8-20, March 2021

[NPL 2] K. Honda et al., “Photonic Gateway for Direct and Protocol-Independent End-to-End User Connections”, OFC2021.

[NPL 3] T. Kanai et al., “In-Line Protocol-Independent Control and Management Method in End-to-End Optical Connections via Photonic Gateway”, ECOC2021.

### SUMMARY OF INVENTION

### Technical Problem

When another optical signal is superimposed on the optical signal output from the subscriber device by using the signal superimposing unit installed in the path, the optical signal output from the opposite subscriber device is modulated. However, since there are variations in the optical signal intensity output from the opposite subscriber devices and the transmission line environment (for example, loss), the intensity of the optical signal input to the signal superimposing unit is not fixed. Therefore, it is unknown to what extent the amplitude of the modulated signal in the signal superimposing unit should be set, and there is a problem that the modulation degree of the optical signal to be superimposed along the way cannot be set to a desired value.

When the optimum superimposition ratio cannot be set in this way, the following adverse effects are considered. If the superimposition ratio is too large, the influence (noise) on the original optical signal becomes large, and as a result, the signal cannot be demodulated by the subscriber device on the opposite side. On the other hand, if the superimposition ratio is too small, the subscriber device on the opposite side cannot receive a newly superimposed signal.

In view of the above-mentioned circumstances, an object of the present invention is to provide a technique that enables a new signal to be superimposed at a superimposition ratio that allows demodulation and reception by a subscriber device on an opposite side, when a new signal is superimposed during transmission of the optical signal.

### Solution to Problem

An aspect of the present invention is an optical node device which includes a modulation amplitude correction unit which generates correction information for correcting an amplitude of a modulated signal based on a control signal so that a superimposition ratio at which the control signal for controlling a subscriber device is superimposed on an optical signal becomes a desired superimposition ratio; a driver which converts the control signal input from the outside into a modulated signal, and adjusts the amplitude of the modulated signal, using the correction information generated by the modulation amplitude correction unit; and a superimposing unit which superimposes the modulated signal adjusted by the driver on the optical signal.

An aspect of the present invention is a signal superimposing method which includes generating correction information for correcting an amplitude of a modulated signal based on a control signal so that a superimposition ratio at which the control signal for controlling a subscriber device is superimposed on an optical signal becomes a desired superimposition ratio; converting the control signal input from the outside into a modulated signal, and adjusting the amplitude of the modulated signal, using the correction information; and superimposing the adjusted modulated signal on the optical signal.

### Advantageous Effects of Invention

When the new signal is superimposed during transmission of the optical signal, the new signal can be superimposed at a superimposition ratio that can be demodulated and received by the subscriber device on the opposite side.

### BRIEF DESCRIPTION OF DRAWINGS

FIG. 1 is a diagram showing a configuration of an optical communication system according to a first embodiment.

FIG. 2 is a diagram showing a configuration example of a signal superimposing unit according to the first embodiment.

FIG. 3 is a flowchart showing the flow of processing of an optical node device according to the first embodiment.

FIG. 4 is a diagram showing a configuration example of a signal superimposing unit according to a second embodiment.

FIG. 5 is a diagram showing a configuration example of a signal superimposing unit according to a third embodiment.

FIG. 6 is a diagram showing a configuration example of a signal superimposing unit according to a fourth embodiment.

FIG. 7 is a diagram showing a configuration example of a signal superimposing unit according to a fifth embodiment.

FIG. 8 is a diagram for explaining a configuration of an optical communication system of the related art.

### DESCRIPTION OF EMBODIMENTS

An embodiment of the present invention will be described below with reference to the drawings.

### First Embodiment

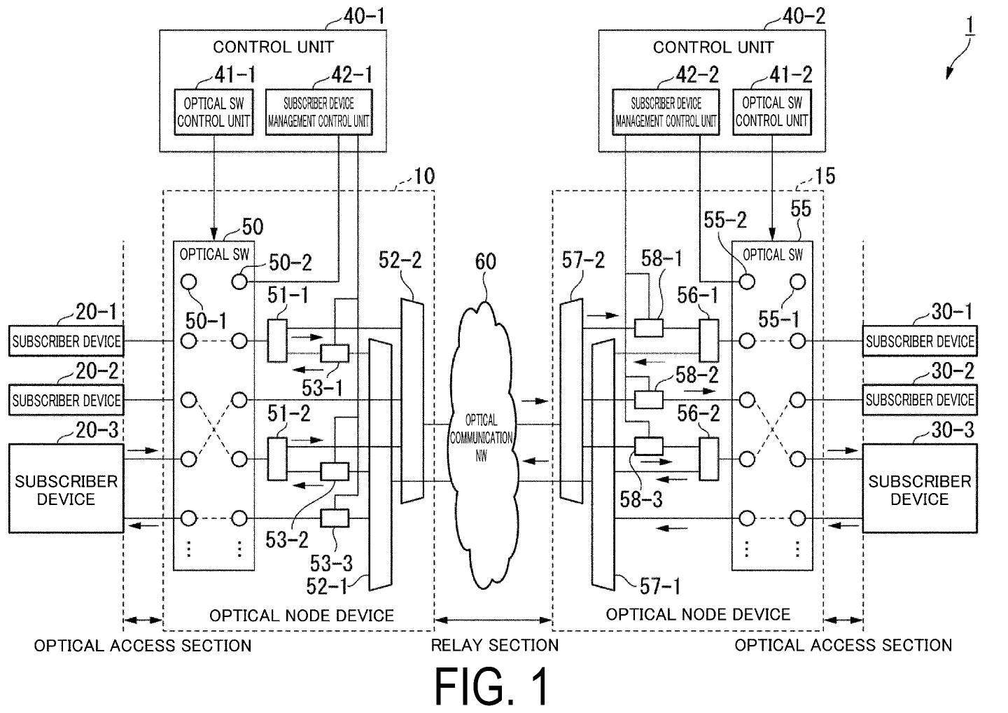

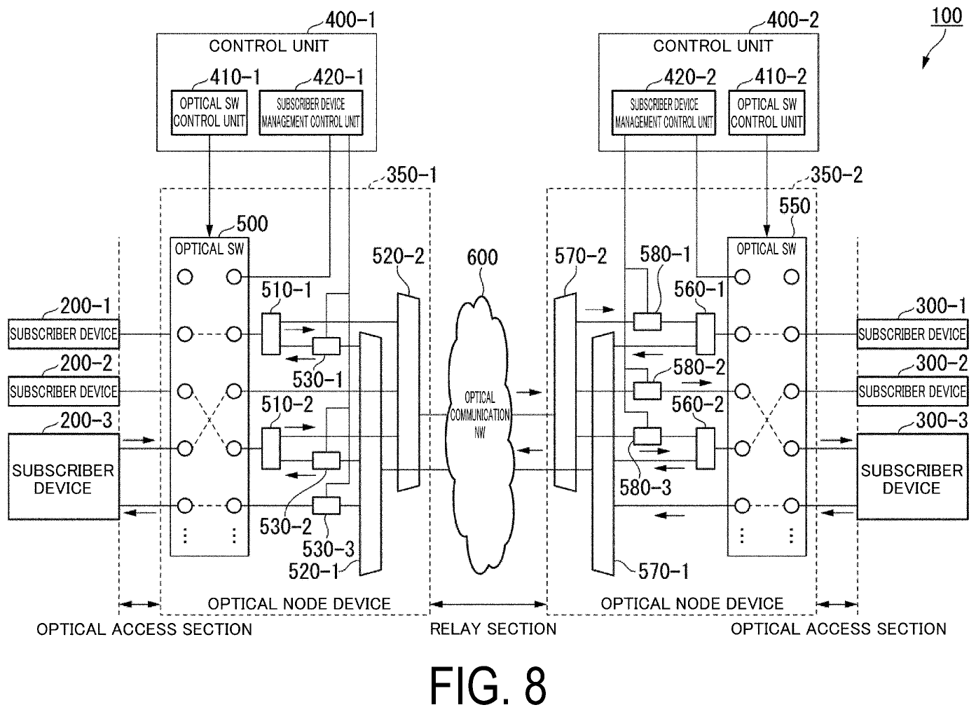

FIG. 1 shows a configuration of an optical communication system 1 according to a first embodiment. The optical communication system 1 includes a plurality of optical node devices 10 and 15, a plurality of subscriber devices 20-1 to 20-3, a plurality of subscriber devices 30-1 to 30-3, and a plurality of control units 40-1 to 40-2. The number of subscriber devices 20 and 30 may be one or more. The configuration of the optical communication system 1 is basically the same as that shown in FIG. 8 except for the configuration of the optical node devices 10 and 15.

An optical transmission line is connected between the optical node device 10 and each subscriber device 20, and between the optical node device 15 and each subscriber device 30. The optical transmission line is, for example, an optical fiber. The optical node device 10 and the optical node device 15 are connected via an optical communication NW60 made up of optical transmission lines.

In the following description, sections between the subscriber devices 20-1 to 20-3 and the optical node device 10, and sections between the subscriber devices 30-1 to 30-3 and the optical node device 15 are described as optical access sections, and sections between the optical node device 10 and the optical node device 15 are described as relay sections. In the example shown in FIG. 1, the subscriber devices 20-1 and 20-2 and the optical node device 10 are connected by a single-core optical transmission line, and the subscriber device 20-3 and the optical node device 10 are connected by a two-core optical transmission line. Similarly, each of the subscriber devices 30-1, 30-2 and the optical node device 15 are connected by the single-core optical transmission line, and the subscriber device 30-3 and the optical node device 15 are connected by the two-core optical transmission line.

The optical node device 10 includes an optical SW 50, a plurality of transmission/reception separation units 51-1 to 51-2, a plurality of wavelength multiplexer/demultiplexers 52-1 to 52-2, and a plurality of signal superimposing units 53-1 to 53-3. The numbers of the optical SW 50, the transmission/reception separation units 51, the wavelength multiplexer/demultiplexers 52, and the signal superimposing units 53 provided in the optical node device 10 may be changed appropriately depending on the system configuration, without being limited to the numbers of devices shown in FIG. 1.

The optical SW 50 is an optical switch having a plurality of ports 50-1 and a plurality of ports 50-2. An optical signal input to a certain port of the optical SW 50 is output from the other port. For example, an optical signal input to the port 50-1 of the optical SW 50 is output from the port 50-2. A connection relation between the port 50-1 and the port 50-2 is set by the control of the control unit 40-1 in the optical SW 50.

The transmission/reception separation units 51-1 to 51-2 are, for example, circulators. The transmission/reception separation units 51-1 to 51-2 each have at least three or more ports. In the following description, it is assumed that the transmission/reception separation units 51-1 to 51-2 each have three ports. A first port of the transmission/reception separation unit 51-1 is connected to a certain port 50-2 of the optical SW 50. A second port of the transmission/reception separation unit 51-1 is connected to the wavelength multiplexer/demultiplexer 52-2. A third port of the transmission/reception separation unit 51-1 is connected to the signal superimposing unit 53-1. The optical signal input to the first port of the transmission/reception separation unit 51-1 is output from the second port. The optical signal input to the second port of the transmission/reception separation unit 51-1 is output from the third port. The optical signal input to the third port of the transmission/reception separation unit 51-1 is output from the first port.

Similarly, the first port of the transmission/reception separation unit 51-2 is connected to any second port of the optical SW 50. A second port of the transmission/reception separation unit 51-2 is connected to the wavelength multiplexer/demultiplexer 52-2. A third port of the transmission/reception separation unit 51-2 is connected to the signal superimposing unit 53-2. The optical signal input to the first port of the transmission/reception separation unit 51-2 is output from the second port 54-2. The optical signal input to the second port of the transmission/reception separation unit 51-2 is output from the third port. The optical signal input to the third port of the transmission/reception separation unit 51-2 is output from the first port.

The wavelength multiplexers/demultiplexers 52-1 to 52-2 multiplex or demultiplex the input optical signals. The wavelength multiplexers/demultiplexers 52-1 to 52-2 are, for example, an arrayed waveguide grating (AWG).

The signal superimposing units 53-1 to 53-3 superimpose the optical signal output from the control unit 40-1 on the optical signal transmitted on the optical transmission line. For example, the signal superimposing units 53-1 to 53-3 are provided on an optical transmission line through which the optical signal sent from the subscriber device 30 to the subscriber device 20 is transmitted. In this case, the signal superimposing units 53-1 to 53-3 superimpose the optical signal output from the control unit 40-1 on the optical signal sent from the subscriber device 30 to the subscriber device 20. The optical signal output from the control unit 40-1 is a control signal including instructions such as setting and wavelength change to the subscriber device 20, for example, and is an AMCC signal.

The optical node device 15 includes an optical SW 55, a plurality of transmission/reception separation units 56-1 to 56-2, a plurality of wavelength multiplexer/demultiplexers 57-1 to 57-2, and a plurality of signal superimposing units 58-1 to 58-3. The number of the optical SW 55, the transmission/reception separation unit 56, the wavelength multiplexer/demultiplexer 57, and the signal superimposing unit 58 provided in the optical node device 15 may be changed appropriately depending on the system configuration, without being limited to the number of devices shown in FIG. 1.

The optical SW 55 is an optical switch having a plurality of ports 55-1 and a plurality of ports 55-2. The optical signal input to a certain port of the optical SW 55 is output from the other port. For example, the optical signal input to the port 55-1 of the optical SW 55 is output from the port 55-2. A connection relation between the port 55-1 and the port 55-2 is set by the control of the control unit 40-2 in the optical SW 55.

The transmission/reception separation units 56-1 to 56-2 are, for example, circulators. The transmission/reception separation units 56-1 to 56-2 have at least three or more ports. In the following description, it is assumed that the transmission/reception separation units 56-1 to 56-2 have three ports. A first port of the transmission/reception separation unit 56-1 is connected to a certain port 55-2 of the optical SW 55. A second port of the transmission/reception separation unit 56-1 is connected to the wavelength multiplexer/demultiplexer 57-2. A third port of the transmission/reception separation unit 56-1 is connected to the signal superimposing unit 58-1. The optical signal input to the first port of the transmission/reception separation unit 56-1 is output from the second port. The optical signal input to the second port of the transmission/reception separation unit 56-1 is output from the third port. The optical signal input to the third port of the transmission/reception separation unit 56-1 is output from the first port.

Similarly, the first port of the transmission/reception separation unit 56-2 is connected to a certain port 55-2 of the optical SW 55. A second port of the transmission/reception separation unit 56-2 is connected to the wavelength multiplexer/demultiplexer 57-1. A third port of the transmission/reception separation unit 56-2 is connected to the signal superimposing unit 58-3. The optical signal input to the first port of the transmission/reception separation unit 56-2 is output from the second port. The optical signal input to the second port of the transmission/reception separation unit 56-2 is output from the third port. The optical signal input to the third port of the transmission/reception separation unit 56-2 is output from the first port.

The signal superimposing units 58-1 to 58-3 superimpose the optical signal output from the control unit 40-2, on the optical signal transmitted on the optical transmission line. For example, the signal superimposing units 58-1 to 58-3 are provided on the optical transmission line through which the optical signal sent from the subscriber device 20 to the subscriber device 30 is transmitted. In this case, the signal superimposing units 58-1 to 58-3 superimpose the optical signal output from the control unit 40-2, on the optical signal sent from the subscriber device 20 to the subscriber device 30. The optical signal output from the control unit 40-2 is a control signal including instructions such as setting and wavelength change to the subscriber device 30, for example, and is an AMCC signal.

The subscriber devices 20 and 30 are provided with a wavelength variable optical transceiver as an optical transceiver. Therefore, the subscriber devices 20 and 30 can communicate with each other by an arbitrary wavelength. The wavelength used for communication by the subscriber devices 20 and 30 is allocated by the control unit 40. For example, the wavelength used for communication by the subscriber device 20 is allocated by the control unit 40-1, and the wavelength used for communication by the subscriber device 30 is allocated by the control unit 40-2. The optical transceiver may be an optical transceiver with an AMCC function. In this case, the used wavelength of the subscriber devices 20 and 30 to be used is controlled via the control signal superimposed by the AMCC. The subscriber devices 20 and 30 are, for example, an optical network unit (ONU) installed in the subscriber's premises.

The control units 40-1 and 40-2 control at least the subscriber devices 20 and 30 and the optical SWs 50 and 55. Here, the control of the subscriber devices 20 and 30 is, for example, allocation of light emission wavelengths to the subscriber devices 20 and 30, an optical stop instruction, an instruction of wavelength change, and the like. The control unit 40-1 sends the optical signal including the optical stop instruction and the instruction of wavelength change which are instructions other than the initial connection to the signal superimposing unit 53, and superimposes the optical signal on an optical signal addressed to the destination subscriber device 20. The control unit 40-2 sends the optical signal including the optical stop instruction and the instruction of wavelength change which are instructions other than the initial connection to the signal superimposing unit 58, and superimposes the optical signal on an optical signal addressed to the destination subscriber device 30. The control of the optical SWs 50 and 55 is, for example, connection setting between ports of the optical SWs 50 and 55, setting of an optical path, and the like. Since the control unit 40-1 and the control unit 40-2 perform the same processing except that the control target is different, the control unit 40-1 will be described as an example.

The control unit 40-1 is provided with an optical SW control unit 41-1 and a subscriber device management control unit 42-1. The optical SW control unit 41-1 controls connection between ports of the optical SW 50. Specifically, the optical SW control unit 41-1 controls connection between ports of the optical SW 50 so that the optical signal sent from the subscriber device 20 is transmitted to a subscriber device (for example, a subscriber device 30-1) to be a transmission destination. Control of the connection between the ports means setting the path so that a port and another port are connected. Further, the optical SW control unit 41-1 controls the connection between ports of the optical SW 50 so that the optical signal addressed to the subscriber device 20 is transmitted to the subscriber device 20.

The subscriber device management control unit 42-1 allocates a wavelength to each subscriber device 20. When the subscriber device management control unit 42-1 allocates a wavelength to each subscriber device 20, the optical SW control unit 41-1 sets a path between ports of the optical SW 50 so that the subscriber device 20 to be allocated with the wavelength is connected to the subscriber device management control unit 42-1. Furthermore, the subscriber device management control unit 42-1 transmits the control signal to be superimposed on the optical signal to the signal superimposing unit 53.

The subscriber device management control unit 42-1 stores a management table. The management table includes information for identifying the subscriber device 20, information on a wavelength assigned to the subscriber device 20, and information on the optical SW 50 to which the subscriber device 20 is connected (for example, information on a port to which the subscriber device 20 is connected). Each control unit 40 includes one or more processors. Each functional unit of each control unit 40 is realized by mounting each control unit 40 on one server.

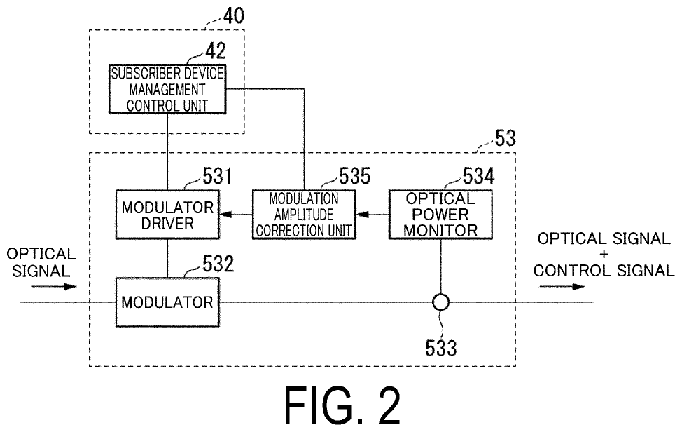

FIG. 2 is a diagram showing a configuration example of the signal superimposing units 53 and 58 in the first embodiment. Since the signal superimposing units 53 and 58 have similar configurations, the signal superimposing unit 53 will be described as an example in FIG. 2. The signal superimposing unit 53 is configured to include, for example, a modulator driver 531, a modulator 532, a splitter 533, an optical power monitor 534, and a modulation amplitude correction unit 535.

The modulator driver 531 is a functional unit for driving the modulator 532. Specifically, the modulator driver 531 receives a control signal output from the subscriber device management control unit 42 included in the control unit 40. The modulator driver 531 converts the control signal input from the subscriber device management control unit 42 into a modulated signal. For example, when the control signal output from the subscriber device management control unit 42 is a simple bit string, the modulator driver 531 generates a modulated signal having an electric amplitude and a waveform matching the characteristics of the modulator 532 on the basis of the input control signal. The amplitude in the present invention is a modulation amplitude, which is different from an electric field amplitude. Further, the modulator driver 531 adjusts the electric amplitude of the modulated signal input to the modulator 532 by using the value output from the modulation amplitude correction unit 535. Adjustment of the electric amplitude of the modulated signal means that the electric amplitude of the modulated signal is converted to have a value output from the modulation amplitude correction unit 535.

The modulator 532 is an optical modulator which modulates the input optical signal by using the modulated signal output from the modulator driver 531. In this way, the optical modulator 532 superimposes a modulated signal on the optical signal. As the optical modulator, for example, an LN (LnNbO₃) modulator, an electroabsorption (EA) modulator, a semiconductor optical amplifier (SOA), a variable optical attenuator (VOA), or the like is known. In the first embodiment, the LN modulator or the EA modulator is used as the optical modulator. The modulator 532 is an aspect of the superimposing unit.

A splitter 533 branches and outputs the optical signal output from the modulator 532 The optical signal branched by the splitter 533 is input to the optical power monitor 534 via the first path, and output to the outside via the second path. In the first embodiment, the optical signal input to the splitter 533 is a signal in which a control signal is superimposed on the optical signal output from the subscriber device 30.

The optical power monitor 534 monitors the optical intensity of the optical signal output from the modulator 532. The optical power monitor 534 sends the monitor result to the modulation amplitude correction unit 535.

The modulation amplitude correction unit 535 generates information for correcting the electrical amplitude of the modulated signal output from the modulator driver 531 (hereinafter referred to as “correction information”) to achieve a desired superimposition ratio, on the basis of the monitor result output from the optical power monitor 534. The modulation amplitude correction unit 535 inputs correction information to the modulator driver 531.

In the first embodiment, the superimposition ratio is represented by the following equation (1).

The superimposition ratio (%)=the control signal optical amplitude/the optical signal average power X100 Equation (1)

Therefore, in order to realize a desired superimposition ratio, it is necessary to set the optical amplitude of the control signal in accordance with the average power of the optical signal. Here, the optical amplitude of the control signal means, for example, a difference in optical power between “1” and “0”, when the control signal is a non-return-to-zero (NRZ) signal. When the control signal is a sine wave or the like, it corresponds to the difference between the optical power of a peak and a valley. The modulation amplitude correction unit 535 generates correction information corresponding to the optical average power input to the modulator 532 according to the above equation (1), and inputs the correction information to the modulator driver 531. The modulator driver 531 outputs a control signal set to a specified amplitude as a modulated signal to the modulator 532 in accordance with the input information.

When a signal specifying the superimposition ratio is input from the subscriber device management control unit 42, the modulation amplitude correction unit 535 may input correction information including such information as to obtain the superimposition ratio specified by the input signal to the modulator driver 531. In this case, the signal superimposing unit 53 may not include the optical power monitor 534.

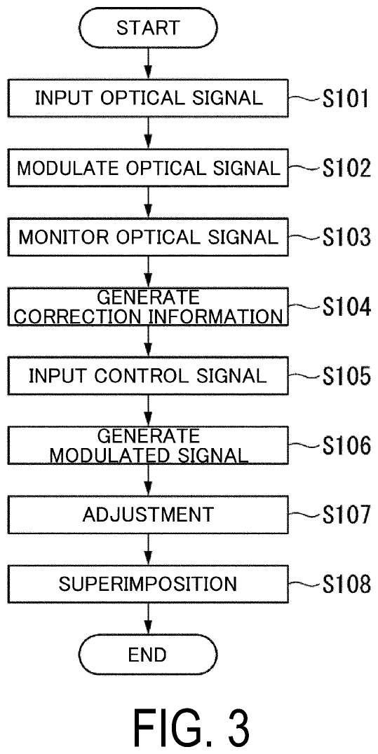

FIG. 3 is a flowchart showing the flow of processing of the optical node device 10 in the first embodiment.

It is assumed that an optical signal be input to the signal superimposing unit 53 of the optical node device 10 (step S101). The modulator 532 of the signal superimposing unit 53 modulates the input optical signal (step S102). The optical signal modulated by the modulator 532 is input to the splitter 533. The splitter 533 branches the input optical signal. The optical signal branched by the splitter 533 is input to the optical power monitor 534 and output to the subscriber device 20.

The optical power monitor 534 monitors the intensity of the optical signal branched by the splitter 533 (step S103). The optical power monitor 534 outputs the modulation amplitude correction unit 535. The modulation amplitude correction unit 535 generates correction information, on the basis of a monitor result output from the optical power monitor 534 (step S104). The modulation amplitude correction unit 535 outputs correction information to the modulator driver 531.

Here, it is assumed that a control signal be input from the control unit 40 to the signal superimposing unit 53 (step S105). The modulator driver 531 converts the control signal into the modulated signal (step S106). The modulator driver 531 adjusts the electric amplitude of the modulated signal to be input to the modulator 532 by using the correction information output from the modulation amplitude correction unit 535 (step S107). The modulator driver 531 outputs the modulated signal after adjusting to the modulator 532. The modulator 532 superimposes the control signal on the optical signal, by modulating the input optical signal, using the modulated signal after adjusting output from the modulator driver 531 (step S108).

According to the optical communication system 100 configured as described above, when a signal is newly superimposed during transmission of an optical signal, the signal can be newly superimposed at a superimposition ratio that can be demodulated and received by the subscriber device on the opposite side. Specifically, in the optical communication system 100, the optical power monitor 534 measures the optical intensity of the optical signal output from the modulator 532, and feeds back the measured value to the modulator driver 531, thereby controlling the modulation amplitude to be newly superimposed in accordance with the optical intensity. Thus, a desired superimposition ratio can be achieved Therefore, when a new signal is superimposed during transmission of the optical signal, the new signal can be superimposed at a superimposition ratio that can be demodulated and received by the subscriber device on the opposite side.

### Second Embodiment

In a second embodiment, the system configuration of the optical communication system 100 is the same as that of the first embodiment, and the configuration of the signal superimposing unit is different from that of the first embodiment. Specifically, the optical intensity of the optical signal modulated by the modulator is monitored in the first embodiment, whereas the second embodiment differs from the first embodiment in that the optical intensity of the optical signal before being modulated by the modulator is monitored. Differences from the first embodiment will be described below.

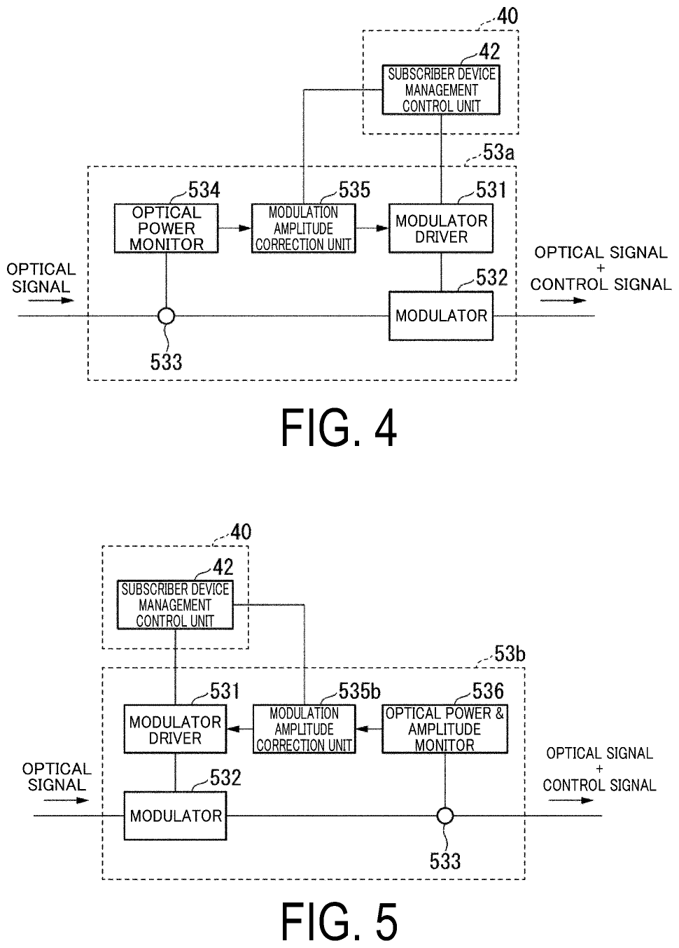

FIG. 4 is a diagram showing a configuration example of a signal superimposing unit 53a in the second embodiment. The signal superimposing unit 53a is configured to include, for example, a modulator driver 531, a modulator 532, a splitter 533, an optical power monitor 534, and a modulation amplitude correction unit 535 1.

When an optical signal is input in the signal superimposing unit 53a, the optical signal is branched by the splitter 533. The optical signal branched by the splitter 533 is input to the optical power monitor 534 via a first path, and input to the modulator 532 via a second path. In the second embodiment, the optical signal input to the splitter 533 is a signal before modulation by the modulator 532. Subsequent processing is the same as in the first embodiment.

According to the optical communication system 100 of the second embodiment configured in this way, it is possible to achieve the same effects as those of the first embodiment.

### Third Embodiment

In a third embodiment, a system configuration of the optical communication system 100 is the same as that of the first embodiment, and the configuration of the signal superimposing unit is different from that of the first embodiment. Specifically, only the optical intensity of the optical signal is monitored in the first embodiment, whereas the third embodiment differs from the first embodiment in that the signal amplitude is also monitored in addition to the optical intensity of the optical signal. Differences from the first embodiment will be described below.

FIG. 5 is a diagram showing a configuration example of a signal superimposing unit 53b in the third embodiment. The signal superimposing unit 53b is configured to include, for example, a modulator driver 531, a modulator 532, a splitter 533, a modulation amplitude correction unit 535b, and an optical power & amplitude monitor 536. The signal superimposing unit 53b is different in configuration from the signal superimposing unit 53 in that it includes the optical power & amplitude monitor 536 and the modulation amplitude correction unit 535b in place of the optical power monitor 534 and the modulation amplitude correction unit 535.

The optical power & amplitude monitor 536 monitors the optical intensity of the optical signal output from the modulator 532 and the amplitude of the optical signal. The optical power & amplitude monitor 536 transmits the monitor result to the modulation amplitude correction unit 535b.

The modulation amplitude correction unit 535b generates correction information to obtain a desired superimposition ratio on the basis of the monitor result output from the optical power & amplitude monitor 536. The modulation amplitude correction unit 535b inputs the correction information to the modulator driver 531.

In the third embodiment, the superimposition ratio is represented by the following equation (2).

The superimposition ratio (%)=control signal amplitude/main signal amplitude×100 Equation (2)

Therefore, in order to realize a desired superimposition ratio, it is necessary to set the optical amplitude of the control signal in accordance with the average power of the optical signal. Here, the optical amplitude of the control signal is, for example, an amplitude difference between “1” and “0”, when the control signal is an NRZ signal. When the control signal is a sine wave or the like, it corresponds to the difference between the peak and the valley. At this time, it is assumed that the amplitude be measured as an electric signal in place of an optical signal. The modulation amplitude correction unit 535b generates correction information corresponding to the optical average power and the signal amplitude input to the modulator 532 according to the equation (2), and inputs the correction information to the modulator driver 531. The modulator driver 531 outputs the control signal set to a specified amplitude as a modulated signal to the modulator 532 in accordance with the input information.

According to the optical communication system 100 of the third embodiment configured as described above, because the amplitude of the optical signal is also monitored in addition to the intensity of the optical signal, it is possible to cope with signal having different extinction ratios or the like even with the same optical power.

The signal superimposing unit 53b may be configured to monitor both the optical power and the signal amplitude before input to the modulator 532, as in the second embodiment. In such a configuration, the signal superimposing unit 53b has a configuration in which the optical power monitor 534 is replaced with the optical power & amplitude monitor 536 and the modulation amplitude correction unit 535 is replaced with the modulation amplitude correction unit 535b in the configuration shown in FIG. 4. Thus, when the optical signal is input in the signal superimposing unit 53b, the optical signal is branched by the splitter 533. The optical signal branched by the splitter 533 is input to the optical power & amplitude monitor 536 via a first path and input to the modulator 532 via a second path. In this case, the optical signal input to the splitter 533 is a signal before modulation by the modulator 532. The optical power & amplitude monitor 536 monitors the optical intensity of the optical signal branched by the splitter 533 and the amplitude of the optical signal. The optical power & amplitude monitor 536 sends the monitor result to the modulation amplitude correction unit 535b. Subsequent processing is the same as the processing shown in the third embodiment.

### Fourth Embodiment

In a fourth embodiment, the system configuration of the optical communication system 100 is the same as that of the first embodiment, and the configuration of the signal superimposing unit is different from that of the first embodiment. Specifically, the fourth embodiment differs from the first embodiment in that a variable optical attenuator is used as an optical modulator. Differences from the first embodiment will be described below.

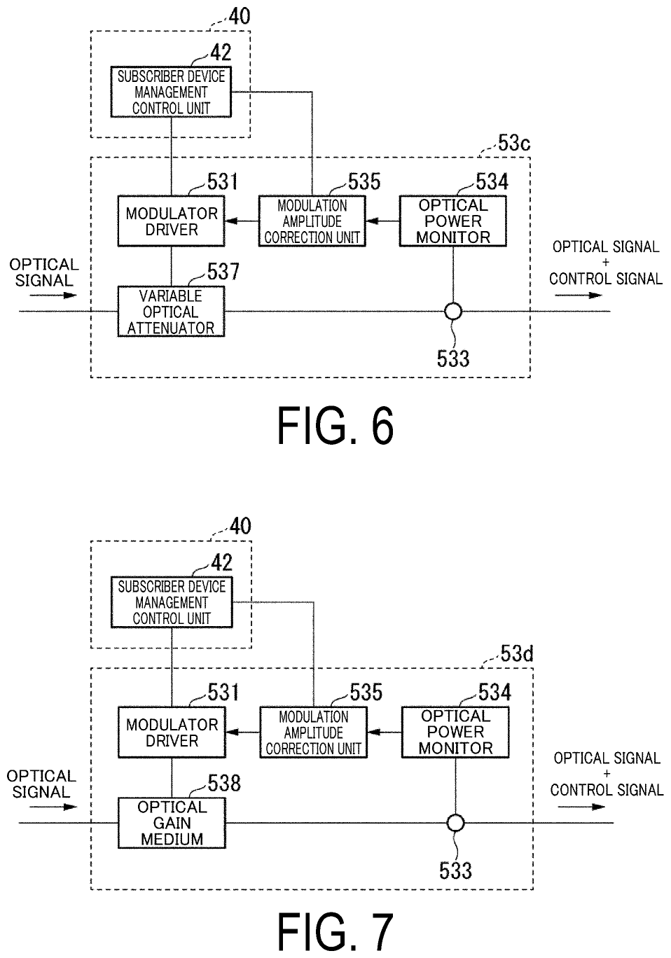

FIG. 6 is a diagram showing a configuration example of a signal superimposing unit 53c in a fourth embodiment. The signal superimposing unit 53c is configured to include, for example, a modulator driver 531, a splitter 533, an optical power monitor 534, a modulation amplitude correction unit 535, and a variable optical attenuator 537. The signal superimposing unit 53c has a configuration different from that of the signal superimposing unit 53 in that the variable optical attenuator 537 is provided in place of the modulator 532. The modulation amplitude correction unit 535 and the modulator driver 531 generate a modulated signal based on a control signal matching the characteristics of the variable optical attenuator 537.

The variable optical attenuator 537 adjusts the intensity of the input optical signal. Specifically, the variable optical attenuator 537 attenuates the intensity of the input optical signal, by modulating the intensity of the input optical signal, using a modulated signal output from the modulator driver 531. The variable optical attenuator 537 is, for example, a VOA. Accordingly, the optical attenuator 537 superimpose the modulated signal on the optical signal. The variable optical attenuator 537 is an aspect of the superimposing unit.

The signal superimposing unit 53c may be configured to monitor the optical power before input to the modulator 532, as in the second embodiment. In such a configuration, the signal superimposing unit 53c has a configuration in which the variable optical attenuator 537 is used as a specific example of the modulator 532 shown in FIG. 4. In this case, the signal superimposing unit 53c performs the same processing as that of the second embodiment except for the operation performed by the variable optical attenuator 537.

The signal superimposing unit 53c may be configured to monitor also the signal amplitude in addition to the optical intensity of the optical signal as in the third embodiment. In such a configuration, the signal superimposing unit 53c is provided with the optical power & amplitude monitor 536 in place of the optical power monitor 534.

### Fifth Embodiment

In a fifth embodiment, the system configuration of the optical communication system 100 is the same as that of the first embodiment, and the configuration of the signal superimposing unit is different from that of the first embodiment. Specifically, the fifth embodiment differs from the first embodiment in that a semiconductor optical amplifier is used as an optical modulator. Differences from the first embodiment will be described below.

FIG. 7 is a diagram showing a configuration example of a signal superimposing unit 53d in the fifth embodiment. The signal superimposing unit 53d is configured to include, for example, a modulator driver 531, a splitter 533, an optical power monitor 534, a modulation amplitude correction unit 535, and an optical gain medium 538. The signal superimposing unit 53d is different in configuration from the signal superimposing unit 53 in that it includes the optical gain medium 538 in place of the modulator 532. The modulation amplitude correction unit 535 and the modulator driver 531 generate a modulated signal based on the control signal matching the characteristics of the optical gain medium 538.

The optical gain medium 538 adjusts the intensity of the input optical signal. Specifically, the optical gain medium 538 amplifies the intensity of the input optical signal, by modulating the intensity using a modulated signal output from the modulator driver 531. The optical gain medium 538 is, for example, an SOA. Accordingly, the optical gain medium 538 superimposes the modulated signal on the optical signal. The optical gain medium 538 is an aspect of the superimposing unit.

The signal superimposing unit 53d may be configured to monitor the optical power before input to the modulator 532, as in the second embodiment. In such a configuration, the signal superimposing unit 53d has a configuration in which the optical gain medium 538 is used as a specific example of the modulator 532 having the configuration shown in FIG. 4. In this case, the signal superimposing unit 53d performs the same processing as that of the second embodiment except for the operation performed by the optical gain medium 538.

The signal superimposing unit 53d may be configured to also monitor the signal amplitude in addition to the optical intensity of the optical signal as in the third embodiment. In such a configuration, the signal superimposing unit 53d is provided with the optical power & amplitude monitor 536 in place of the optical power monitor 534.

Some functional units of the optical node devices 10 and 15, and the control unit 40 in the embodiments described above may be realized by a computer. In such a case, the program for realizing this function may be recorded on a computer-readable recording medium, and the program recorded on the recording medium may be read and executed by the computer system. Note that the “computer system” mentioned herein includes an OS and hardware such as peripheral devices.

In addition, a “computer-readable recording medium” refers to a portable medium such as a flexible disc, a magneto-optical disk, a ROM, or a CD-ROM, or a storage device such as a hard disk built in a computer system. Furthermore, the “computer-readable recording medium” may include a medium that dynamically holds a program for a short time, such as a communication line in a case where the program is transmitted via a network such as the Internet or a communication line such as a telephone line, and a medium that holds the program for a certain time, such as a volatile memory inside a computer system serving as a server or a client in that case. Also, the above program may be for realizing a part of the functions described above, may be for realizing the functions described above in combination with a program already recorded in a computer system, or may be for realizing the functions described above using a programmable logic device such as an FPGA.

Although the embodiment of the present invention has been described in detail with reference to the drawings, a specific configuration is not limited to this embodiment, and design within the scope of the gist of the present invention, and the like are included.

### INDUSTRIAL APPLICABILITY

The present invention is applicable to an optical communication system which superimposes the control signal on the optical signal.

### REFERENCE SIGNS LIST

10, 15 Optical node device
20, 20-1 to 20-3, 30, 30-1 to 30-3 Subscriber device
40, 40-1 to 40-2 Control units
41, 41-1 to 41-2 Optical SW control unit
42, 42-1 to 42-2 Subscriber device management control unit
51, 51-1 to 51-2, 56, 56-1 to 56-2 Transmission/reception separation unit
52, 52-1 to 52-2, 57, 57-1 to 57-2 Wavelength multiplexer/demultiplexer
53, 53a, 53b, 53c, 53d, 53-1 to 53-3, 58, 58-1 to 58-3 Signal superimposing unit
531 Modulator driver
532 Modulator
533 Splitter
534 Optical power monitor
535 Modulation amplitude correction unit
536 Optical power & amplitude monitor
537 Variable optical attenuator
538 Optical gain medium

1. An optical node device comprising:
a modulation amplitude corrector configured to generate correction information for correcting an amplitude of a modulated signal based on a control signal so that a superimposition ratio at which the control signal for controlling a subscriber device is superimposed on an optical signal becomes a desired superimposition ratio;
a driver configured to convert the control signal input from the outside into a modulated signal, and adjusts the amplitude of the modulated signal, using the correction information generated by the modulation amplitude corrector; and
a superimposing unit configured to superimpose the modulated signal adjusted by the driver on the optical signal.

2. The optical node device according to claim 1, further comprising:
a monitor configured to monitor at least the intensity of the optical signal before or after the modulated signal is superimposed,
wherein the modulation amplitude corrector generates the correction information on the basis of the intensity of the optical signal obtained by the monitor.

3. The optical node device according to claim 2, further comprising:
a brancher configured to branch the input optical signal and outputs the optical signal to the monitor and the superimposing unit when the monitor monitors at least the intensity of the optical signal before superimposing the modulated signal.

4. The optical node device according to claim 2, further comprising:
a brancher configured to branch the input optical signal and outputs the optical signal to the monitor and the outside, at a rear state, when the monitor monitors at least the intensity of the optical signal after superimposing the modulated signal.

5. The optical node device according to claim 1,
wherein the modulation amplitude corrector generates the correction information including information such that the superimposition ratio specified by the input signal is obtained when a signal specifying the superimposition ratio is input from the outside.

6. The optical node device according to claim 2,
wherein the monitor further monitors the amplitude of the optical signal, and the modulation amplitude corrector generates the correction information on the basis of the intensity of the optical signal obtained by the monitor and the amplitude of the optical signal.

7. The optical node device according to claim 1,
wherein the superimposing unit is one of an LnNbO3 (LN) modulator, an electroabsorption (EA) modulator, a semiconductor optical amplifier (SOA), and a variable optical attenuator (VOA).

8. A signal superimposing method comprising:
generating correction information for correcting an amplitude of a modulated signal based on a control signal so that a superimposition ratio at which the control signal for controlling a subscriber device is superimposed on an optical signal becomes a desired superimposition ratio;
converting the control signal input from the outside into a modulated signal, and adjusting the amplitude of the modulated signal, using the correction information; and superimposing the adjusted modulated signal on the optical signal.
